(19) United States
(12) Patent Application Publication
(10) Pub. No.: US 2026/0135194 A1
(43) Pub. Date: May 14, 2026

(54) SUPERCELL FOR BATTERY ASSEMBLY AND METHOD OF ASSEMBLING SUPERCELL

(71) Applicant: Caterpillar Inc., Peoria, IL (US)

(72) Inventor: Wellington Ying-wei Kwok, Dunlap, IL (US)

(73) Assignee: Caterpillar Inc., Peoria, IL (US)

(21) Appl. No.: 18/940,906

(22) Filed: Nov. 8, 2024

(51) Int. Cl. H01M 10/6569; H01M 10/613; H01M 10/647; H01M 10/6551; H01M 10/6555; H01M 10/6557; H01M 50/211; H01M 50/293; H01M 50/54

(52) U.S. Cl. CPC H01M 10/6569; H01M 10/613; H01M 10/647; H01M 10/6551; H01M 10/6555; H01M 10/6557; H01M 50/211; H01M 50/293; H01M 50/54

(57) ABSTRACT

A supercell for the battery assembly includes the housing defining an interior space. The housing extends along each of the longitudinal axis, the lateral axis, and the transverse axis. The supercell also includes the cell terminal coupled with the housing. The supercell further includes at least two pouch battery cells disposed within the interior space of the housing. The at least two pouch battery cells are disposed adjacent to each other along the lateral axis. The supercell includes the coupling system that couples each of the at least two pouch battery cells with the cell terminal. The supercell also includes the cooling system for the at least two pouch battery cells. The cooling system is at least partially disposed within the interior space of the housing.

### TECHNICAL FIELD

The present disclosure relates to a battery assembly, a supercell for the battery assembly, and a method of assembling the supercell of the battery assembly.

### BACKGROUND

A battery system can be used in a variety of applications as a means of electric power supply. For example, battery systems are being increasingly implemented in passenger vehicles, construction machines, and the like, to provide electric power supply.

Battery systems include a number of battery cells that store electrical power and distribute the stored electrical power. In some cases, the battery cells include pouch-type battery cells. Integration of pouch-type battery cells in a battery system often requires significant research and specialized module design. Further, an intensive and unique design process has to be developed for different pouch cell configurations, which may be time consuming and may increase costs associated with battery systems. Moreover, conventional arrangements of the battery cells may not include components that address issues of cell expansion during a charging of the pouch-type battery cells.

U.S. Application Number 2023/0299379 describes a battery module that includes a first pouch battery cell and a neighboring second pouch battery cell. The battery module also includes a dielectric fluid in direct contact with and in circulation over and around each of the first and second pouch cells. The battery module additionally includes an immersion barrier positioned between the first and second pouch cells and defining an opening for controlling passage of the dielectric fluid between the first and the second pouch cells. The barrier thereby facilitates localization of a thermal runaway event in the first pouch cell by minimizing transfer of high temperature gases between the first and the second pouch cells via the dielectric fluid and controls propagation of the thermal runaway event in the module. The battery module further includes an enclosure housing and retaining each of the first and second pouch cells, the dielectric fluid, and the immersion barrier.

### SUMMARY OF THE DISCLOSURE

In an aspect of the present disclosure, a supercell for a battery assembly is provided. The supercell includes a housing defining an interior space. The housing extends along each of a longitudinal axis, a lateral axis, and a transverse axis. The supercell also includes a cell terminal coupled with the housing. The supercell further includes at least two pouch battery cells disposed within the interior space of the housing. The at least two pouch battery cells are disposed adjacent to each other along the lateral axis. The supercell includes a coupling system that couples each of the at least two pouch battery cells with the cell terminal. The supercell also includes a cooling system for the at least two pouch battery cells. The cooling system is at least partially disposed within the interior space of the housing.

In another aspect of the present disclosure, a battery assembly is provided. The battery assembly includes a battery housing. The battery assembly also includes a plurality of supercells disposed within the battery housing. Each of the plurality of supercells includes a housing defining an interior space. The housing extends along each of a longitudinal axis, a lateral axis, and a transverse axis. Each of the plurality of supercells also includes a cell terminal coupled with the housing. Each of the plurality of supercells further includes at least two pouch battery cells disposed within the interior space of the housing. The at least two pouch battery cells are disposed adjacent to each other along the lateral axis. Each of the plurality of supercells includes a coupling system that couples each of the at least two pouch battery cells with the cell terminal. Each of the plurality of supercells also includes a cooling system for the at least two pouch battery cells. The cooling system is at least partially disposed within the interior space of the housing.

In yet another aspect of the present disclosure, a method of assembling a supercell of a battery assembly is provided. The method includes providing a housing of the supercell defining an interior space. The housing extends along each of a longitudinal axis, a lateral axis, and a transverse axis. A cell terminal of the supercell is coupled with the housing. The method also includes disposing at least two pouch battery cells of the supercell within the interior space of the housing. The at least two pouch battery cells are disposed adjacent to each other along the lateral axis. The method further includes coupling each of the at least two pouch battery cells with the cell terminal via a coupling system of the supercell. The method includes coupling a cooling system of the supercell with the at least two pouch battery cells. The cooling system is at least partially disposed within the interior space of the housing.

Other features and aspects of this disclosure will be apparent from the following description and the accompanying drawings.

### BRIEF DESCRIPTION OF THE DRAWINGS

FIG. 1 is a schematic perspective view of a battery assembly, according to an example of the present disclosure;

FIG. 2 is an exploded view of a supercell of the battery assembly of FIG. 1, according to an example of the present disclosure;

FIG. 3A is a schematic side view of two pouch battery cells assembled with a holder associated with the supercell of FIG. 2;

FIG. 3B is a schematic front view of the two pouch battery cells assembled with the holder of FIG. 3A;

FIG. 4A is a schematic side view illustrating a compressible member disposed between the two pouch battery cells associated with the supercell of FIG. 2;

FIG. 4B is a schematic side view of a supercell that may be associated with the battery assembly of FIG. 1, the supercell includes three pouch battery cells, according to another example of the present disclosure;

FIGS. 5A, 5B, and 5C illustrate a coupling system associated with the supercell of FIGS. 2 to 4A;

FIG. 6 is a schematic side view of a supercell that may be associated with the battery assembly of FIG. 1, the supercell includes a cooling system, according to another example of the present disclosure;

FIG. 7A is a schematic top view of a number of channel assemblies associated with the cooling system of FIG. 6 in a compressed state;

FIG. 7B is a schematic top view of the number of channel assemblies in an original state;

FIG. 8 is a schematic perspective view of a channel assembly of the cooling system of FIG. 6; and

FIG. 9 is a flowchart for a method of assembling the supercell of the battery assembly, according to an example of the present disclosure.

### DETAILED DESCRIPTION

Wherever possible, the same reference numbers will be used throughout the drawings to refer to the same or like parts.

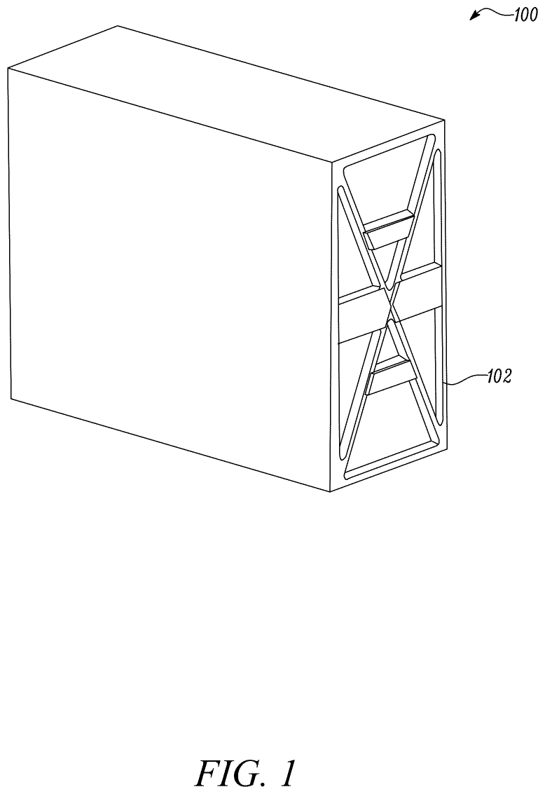

Referring to FIG. 1, a schematic perspective view of a battery assembly 100 is illustrated, according to an example of the present disclosure. The battery assembly 100 may be used in a variety of applications as a means of electric power supply. For example, the battery assembly 100 may be used in a machine, a passenger vehicle, and the like, to provide power supply to one or more components associated therewith. The machine may include a moving machine or a stationary machine. The machine may include a work machine or a construction machine, such as, a mining truck, a wheel loader, and the like. Although the single battery assembly 100 is shown herein, the machine may include multiple such battery assemblies to provide a desired amount of electrical power.

The battery assembly 100 includes a battery housing 102. The battery housing 102 is rectangular in shape herein. However, the battery housing 102 may have any other shape or design, based on application requirements. The battery housing 102 may include a single piece housing or the battery housing 102 may be formed by assembling multiple plates, covers, and the like.

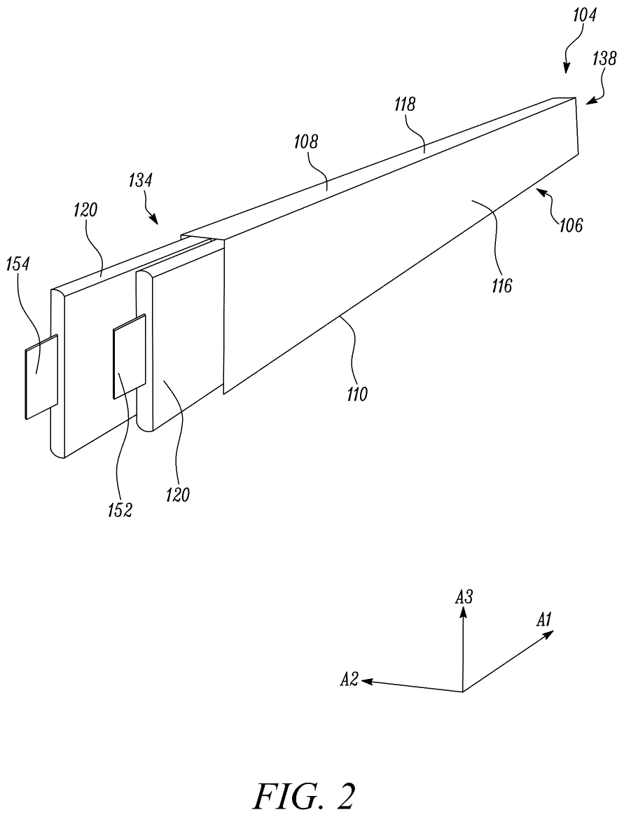

Referring to FIGS. 1 and 2, the battery assembly 100 also includes a number of supercells 104 (only one of which is shown in FIG. 2) disposed within the battery housing 102.

The battery assembly 100 may include one or more battery stacks (not shown) disposed adjacent to each other. Each battery stack may include multiple supercells 104 that are arranged in a stacked relationship. The supercells 104 are electrically coupled together to provide a desired amount of power output and voltage output. The battery assembly 100 may include any number of supercells 104 that may be arranged in any configuration, based on application requirements. Further, the supercells 104 may be arranged in a series arrangement, a parallel arrangement, or a combination thereof.

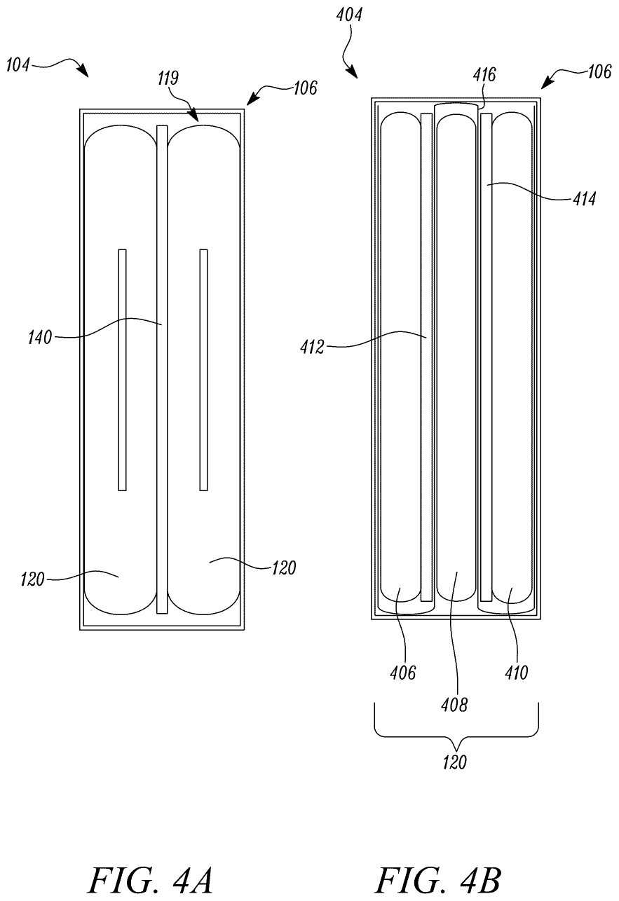

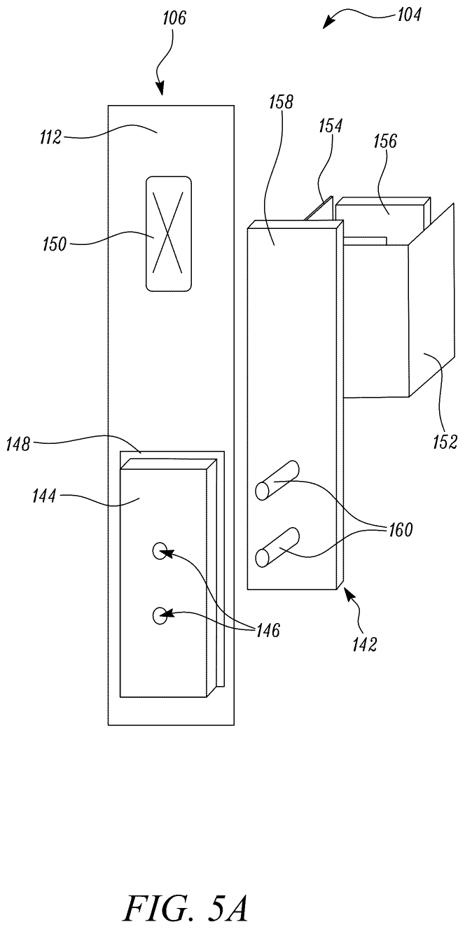

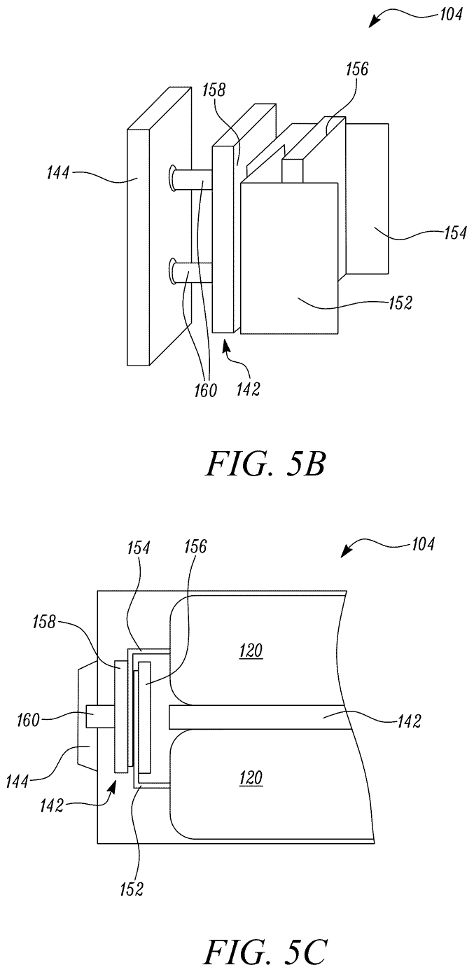

Referring to FIG. 2, an exploded view of the single supercell 104 is illustrated, according to an example of the present disclosure. It should be noted that the details of the supercell 104 provided herein are equally applicable to other supercells 104. The supercell 104 includes a housing 106. The housing 106 includes an upper wall 108, a lower wall 110, a front wall 112 (shown in FIGS. 5A and 5C), a first sidewall 116, and a second sidewall 118. The housing 106 defines an interior space 119 (shown in FIG. 4A). The housing 106 is embodied as an open rectangular channel, that can be an extruded metal channel, folded and welded from a flat sheet, or formed by any other technique. The housing 106 extends along each of a longitudinal axis A1, a lateral axis A2, and a transverse axis A3. In the illustrated example of FIG. 2, the housing 106 is rectangular in shape. In some examples, the housing 106 may be made of aluminum, composites, plastics, and/or any other suitable material.

The supercell 104 is a high-capacity cell that may be made of two or more smaller cells connected in parallel. Specifically, the supercell 104 includes two or more pouch battery cells 120 disposed within the interior space 119 of the housing 106. The two or more pouch battery cells 120 are disposed adjacent to each other along the lateral axis A2. In the illustrated example of FIG. 2, the supercell 104 includes two pouch battery cells 120. However, it should be noted that each supercell 104 may include three or more pouch battery cells similar to the pouch battery cells 120, based on application requirements. In some examples, the pouch battery cells 120 may include standard Verband der Automobilindustrie (VDA) format pouch cells with opposite terminals. It should be noted that cell tabs 152, 154 of the pouch battery cells 120 may be arranged in any type of configuration known to a person skilled in the art.

The number of pouch battery cells 120 may incorporate, for example, a lithium-ion battery technology to store electrical power and distribute the stored electrical power at a supercell voltage and a supercell amperage. It should be noted that the power distribution and power storage characteristics of each supercell 104 may be defined at least in part on the configuration of the number of pouch battery cells 120 included in the corresponding supercell 104. In other examples, the supercell 104 may embody any other type of battery technology/cell chemistry, such as, a nickel metal hydride battery technology, a zinc-based battery technology, a lithium-based battery technology, a sodium-based battery technology, and the like. Further, the pouch battery cells 120 may include any capacity, voltage, energy, etc.

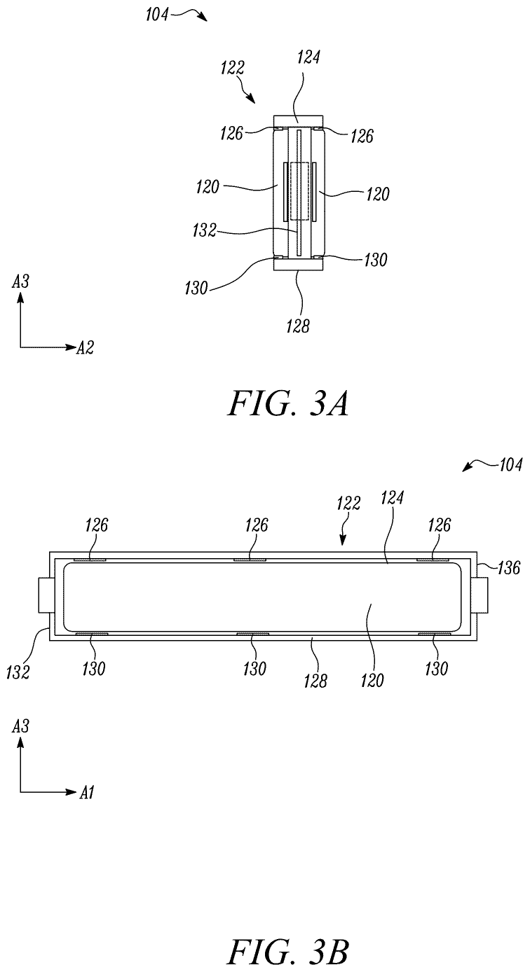

Referring now to FIGS. 3A and 3B, in some examples, the supercell 104 includes a holder 122 disposed within the housing 106 (see FIG. 2) and coupled with each of the two or more pouch battery cells 120. The holder 122 and the two pouch battery cells 120 are disposed within the housing 106 (see FIG. 2) as a unit.

The holder 122 includes a top wall 124 extending along the longitudinal axis A1 of the housing 106. The top wall 124 includes a number of first tabs 126. In the illustrated example of FIGS. 3A and 3B, the top wall 124 includes six first tabs 126 (only three of which are shown in FIG. 3B). The holder 122 also includes a bottom wall 128 spaced apart from the top wall 124 and extending along the longitudinal axis A1 of the housing 106. The number of first tabs 126 extend orthogonally towards the bottom wall 128. The bottom wall 128 includes a number of second tabs 130. The number of second tabs 130 extend orthogonally towards the top wall 124. In the illustrated example of FIGS. 3A and 3B, the bottom wall 128 includes six second tabs 130 (only three of which are shown in FIG. 3B). Each of the number of first tabs 126 and the number of second tabs 130 couple the two or more pouch battery cells 120 with the holder 122. The first tabs 126 and the number of second tabs 130 retain the pouch battery cells 120 in contact with the holder 122.

The holder 122 further includes a first wall 132 extending along the transverse axis A3 of the housing 106 from the top wall 124 to the bottom wall 128 and disposed at a first end 134 (see FIG. 2) of the housing 106. The holder 122 includes a second wall 136 extending along the transverse axis A3 of the housing 106 from the top wall 124 to the bottom wall 128 and disposed at a second end 138 (see FIG. 2) of the housing 106.

Referring now to FIG. 4A, the supercell 104 further includes a compressible member 140 disposed between the two or more pouch battery cells 120. The compressible member 140 may include a foam, a plastic, a composite, or other material to provide cell compression to the pouch battery cells 120 as required. In some examples, the compressible member 140 may include a shielding component to shield, insulate, and/or otherwise prevent heat from traveling between the adjacent pouch battery cells 120.

Referring now to FIG. 4B, a schematic side view of a supercell 404 that may be associated with the battery assembly 100 of FIG. 1 is illustrated, according to another example of the present disclosure. The supercell 404 is similar to the supercell 104 explained in relation to FIGS. 2 to 4A, with common components referred to by the same numerals. However, the two or more pouch battery cells 120 includes three pouch cells 406, 408, 410. Specifically, the two or more pouch battery cells 120 includes a first pouch cell 406, a second pouch cell 408, and a third pouch cell 410 disposed adjacent to each other. The supercell 104 includes a first compressible member 412 disposed between the first pouch cell 406 and the second pouch cell 408. Moreover, the supercell 104 includes a second compressible member 414 disposed between the second pouch cell 408 and the third pouch cell 410. The first and second compressible members 412, 414 are similar to the compressible member 140 (see FIG. 4A) in terms of material and function.

The supercell 104 further includes a heat dissipating sheet 416 wrapped around each of the first pouch cell 406, the second pouch cell 408, and the third pouch cell 410. A portion of the heat dissipating sheet 416 is disposed between the first pouch cell 406 and the housing 106, and a portion of the heat dissipating sheet 416 is disposed between the third pouch cell 410 and the housing 106. Specifically, in this example, the heat dissipating sheet 416 is wrapped around the middle, second pouch cell 408 and extends to a surface of the first and second pouch cells 406, 408, such that the heat dissipating sheet 416 is in direct contact with an interior surface of the housing 106 in order to enable effective heat removal from the second pouch cell 408. In an example, the heat dissipating sheet 416 is made of a graphite material. Alternatively, the heat dissipating sheet 416 may be made of any other material known to a person skilled in the art.

FIGS. 5A, 5B, and 5C illustrate a coupling system 142 associated with the supercell 104 of FIGS. 2 to 4A. As shown in FIG. 5A, the supercell 104 includes a cell terminal 144 coupled with the housing 106. The cell terminal 144 is coupled to the front wall 112 of the housing 106. The cell terminal 144 includes a pair of through-holes 146. Further, an insulator 148 is disposed between the front wall 112 and the cell terminal 144.

The supercell 104 also includes the coupling system 142 that couples each of the two or more pouch battery cells 120 with the cell terminal 144. The supercell 104 further includes a burst disc 150 coupled to the front wall 112 of the housing 106. The burst disc 150 may dislodge from the supercell 104 when a pressure within the supercell 104 exceeds a predefined pressure value. In other words, during a thermal event in one or more of the pouch battery cells 120, thermal runaway gases may be generated inside the supercell 104 that may increase the pressure inside the supercell 104. The pressure generated due to the thermal runaway gases may dislodge the burst disc 150 from the supercell 104.

As shown in FIG. 5B, each pouch battery cell 120 includes a corresponding cell tab 152, 154 that is electrically coupled with the cell terminal 144. The cell tab 152, 154 are bent from a flat terminal foil to a 90 degrees angle in order to place in between a first plate and a second plate 156, 158 for welding. The coupling system 142 includes the first plate 156, and the second plate 158 including a pair of projections 160. The pair of projections 160 of the second plate 158 are fixedly coupled with the cell terminal 144. Each through-hole 146 (see FIG. 5A) of the cell terminal 144 receives a corresponding projection 160 of the second plate 158. Further, the pair of projections 160 of the second plate 158 may be coupled with the cell terminal 144 by welding.

As shown in FIGS. 5B and 5C, a portion of the cell tab 152, 154 of each of the two or more pouch battery cells 120 is disposed between the first plate 156 and the second plate 158 and fixedly coupled with each of the first plate 156 and the second plate 158. In some examples, the first plate 156, the second plate 158, and the cell tabs 152, 154 are coupled to each other by welding.

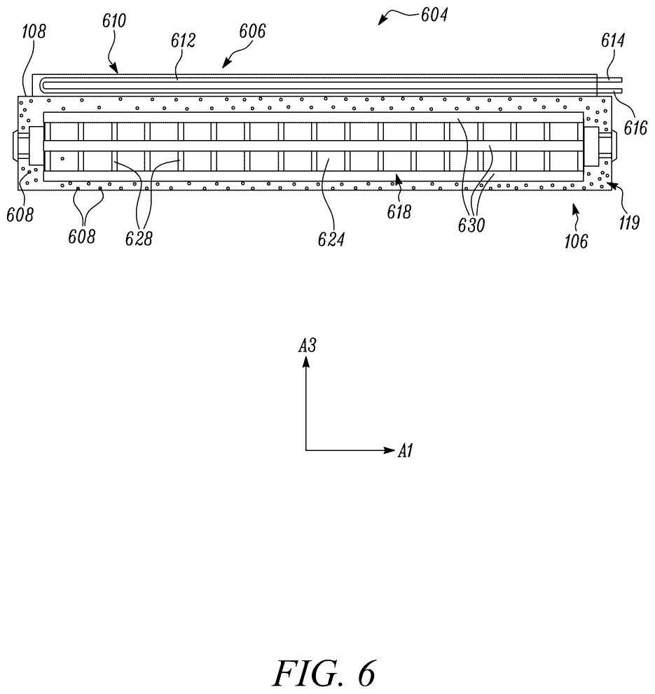

Referring now to FIG. 6, a schematic side view of a supercell 604 that may be associated with the battery assembly 100 of FIG. 1 is illustrated, according to yet another example of the present disclosure. The supercell 604 is similar to the supercell 104 explained in relation to FIGS. 2 to 4A, with common components referred to by the same numerals. The supercell 604 includes the two or more pouch battery cells 120. The two or more pouch battery cells 120 includes a first pouch cell 624 and a second pouch cell 626. The supercell 604 further includes a cooling system 606 for the two or more pouch battery cells 120. The cooling system 606 is at least partially disposed within the interior space 119 of the housing 106.

The cooling system 606 includes a dielectric fluid 608 received within the interior space 119 of the housing 106. The dielectric fluid 608 has a low boiling point. The dielectric fluid 608 may have a boiling point between, for example, 30-40° Celsius. Heat dissipation from the pouch cells 120 can be quickly absorbed by liquid boiling (i.e., latent heat) and directed upwards to reject the heat to the outside. The process is known as 2-phase immersion cooling. It should be noted that the supercell 604 is completely sealed in order to create an internal vapor chamber to facilitate condensation and evaporation of the dielectric fluid 608.

Each of the two or more pouch battery cells 120 is immersed in the dielectric fluid 608. The dielectric fluid 608 is in direct contact with, substantially surrounds, and circulates over and around each of the pouch battery cells 120. The dielectric fluid 608 may be circulated via a pressure source, such as an external fluid pump (not shown), to remove heat from the pouch battery cells 120, while the supercell 604 generates/stores electrical energy. Generally, during normal operation of the supercell 604, the dielectric fluid 608 is effective in absorbing thermal energy released by the pouch battery cells 120 and facilitating transfer of the thermal energy out of the supercell 604.

Further, in some examples, an interior surface of the upper wall 108 of the housing 106 may be roughened or textured or attached with a heat sink to increase heat-transfer/condensing surface area. The cooling system 606 also includes a condenser 610 disposed atop the housing 106 for heat exchange with the dielectric fluid 608. The condenser 610 serves to effect heat removal for the supercell 604. Specifically, the condenser 610 is coupled at the upper wall 108 of the housing 106. The condenser 610 may include a cold plate. The condenser 610 includes a channel 612 for coolant to flow to transport heat away from the supercells 604. The condenser 610 may also include a number of fins that may be attached directly to a heat removal (bottom) plate of the condenser 610 that interfaces with the supercell 604 to provide additional heat-transfer surfaces for the coolant and therefore an increased rate of heat transfer. Each supercell 604 may have an individual condenser, or the condenser 610 may span across multiple supercells 604 of the battery assembly 100 (see FIG. 1), as per requirements. The low temperature coolant flows into the condenser 610 through an inlet 614 and the high temperature coolant flows out of an outlet 616 of the condenser 610 after heat exchange with the supercell 604. The condenser 610 may have any design and shape known to a person skilled in the art.

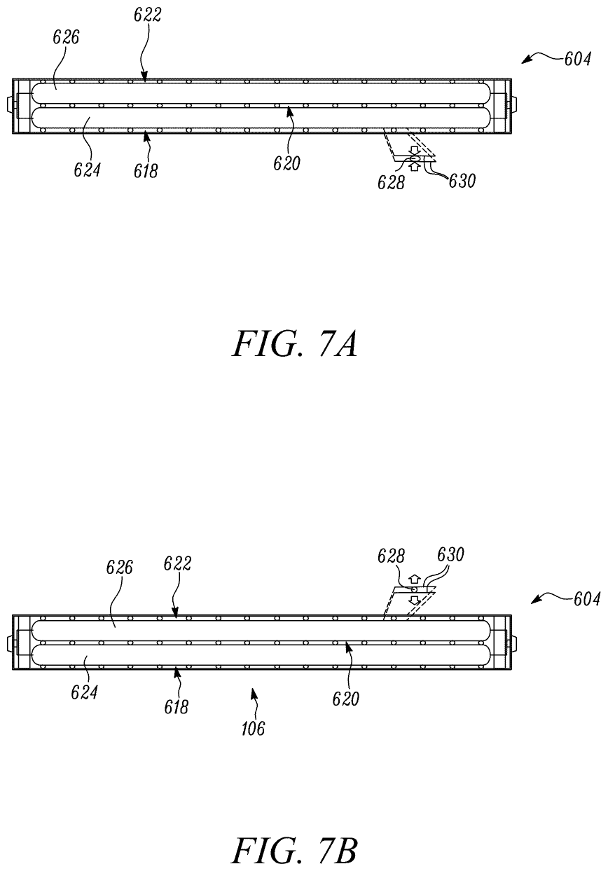

As shown in FIGS. 6 to 7B, the cooling system 606 further includes a number of channel assemblies 618, 620, 622 disposed within the interior space 119 of the housing 106. Each of the number of channel assemblies 618, 620, 622 is made of a compressible material. Each of the number of channel assemblies 618, 620, 622 may be made of a metal, an alloy, a plastic, or a composite.

As shown in FIGS. 7A and 7B, the number of channel assemblies 618, 620, 622 includes a first channel assembly 618, a second channel assembly 620, and a third channel assembly 622. The first channel assembly 618 from the number of channel assemblies 618, 620, 622 is disposed between the housing 106 and the first pouch cell 624 from the two or more pouch battery cells 120. Further, the second channel assembly 620 from the number of channel assemblies 618, 620, 622 is disposed between the first pouch cell 624 and the second pouch cell 626 from the two or more pouch battery cells 120. Furthermore, the third channel assembly 622 from the number of channel assemblies 618, 620, 622 is disposed between the housing 106 and the second pouch cell 626.

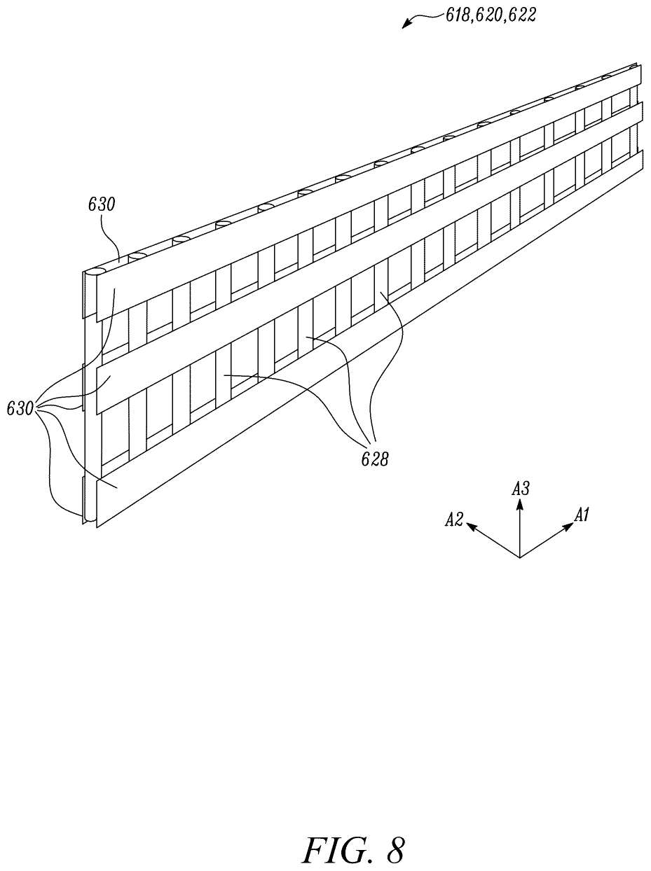

Referring now to FIG. 8, each of the number of channel assemblies 618, 620, 622 includes a number of tubes 628 that extend along the transverse axis A3 and a number of plates 630 that extend along the longitudinal axis A1. The number of tubes 628 are embodied as hollow tubes. Each of the number of channel assemblies 618, 620, 622 includes three plates 630 herein, however, the number of channel assemblies 618, 620, 622 may include only two plates. The plates 630 are used to hold down and position the multiple tubes 628. Each tube 628 from the number of tubes 628 is coupled to each of the number of plates 630. Each tube 628 from the number of tubes 628 allows passage of the dielectric fluid 608 (see FIG. 6) therethrough. The tubes 628 of each channel assembly 618, 620, 622 may work as a liquid reservoir for the dielectric fluid 608. The tubes 628 may include microchannels to allow passage of the dielectric fluid 608. The tubes 628 may be made of a metal, a heat conducting material, or an insulating material. The main function of the channel assemblies 618, 620, 622 is to allow free liquid flow along surfaces of the first and second pouch cells 624, 626.

Referring again to FIG. 7A, as the first and second pouch cells 624, 626 expand during a recharging process of the first and second pouch cells 624, 626, the channel assemblies 618, 620, 622 are compressed, thereby accommodating the expansion of the first and second pouch cells 624, 626.

Referring now to FIG. 7B, as the first and second pouch cells 624, 626 contract during a discharge process of the first and second pouch cells 624, 626, the channel assemblies 618, 620, 622 spring-back to their original shape. It should be noted that one or more components of the cooling system 606 may be incorporated in the supercells 104, 404 (see FIGS. 2 and 4B, respectively), without limiting the scope of the present disclosure.

It is to be understood that individual features shown or described for one embodiment may be combined with individual features shown or described for another embodiment. The above-described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure is related to the supercell 104, 404, 604 for the battery assembly 100. The present disclosure teaches a concept in which parallelly connected pouch cells can be converted into a prismatic cell format that can be easily integrated to an existing module or battery system design. The supercell 104, 404, 604 presents a simple modular cell subassembly that consists of two or more pouch cells 120 connected in parallel.

The present disclosure enables rapid design and development of the supercell 104, 404, 604 including the pouch battery cells 120. The supercell 104, 404, 604 provides a simple packaging technique for the pouch battery cells 120 and also provides an efficient thermal design for the pouch battery cells 120. Further, the design of the supercell 104, 404, 604 described herein may be used across different pouch cell configurations, which may reduce time and costs required to design and package the pouch battery cells 120 having different pouch cell configurations. Specifically, the present disclosure may eliminate the need for design/re-design individual module structures when new configurations of battery cells are developed and produced. The present disclosure may be particularly useful in manufacturing cell-to-pack configuration. Furthermore, the supercell 104, 404, 604 described herein is cost-effective.

The supercell 104, 404, 604 is formed from the two or more pouch battery cells 120 that are connected in parallel to produce a high capacity supercell. The supercell 104, 404, 604 is formed with simple subassemblies that can be easily integrated to an existing supercell, without needing extensive redesigning of the existing supercell, a mechanical structure of a battery assembly, or a thermal interface(s).

Further, the supercell 604 presents a self-contained sealed modular cell subassembly with an integrated high-efficient cooling design based on incorporation of the 2-phase immersion cooling technique provided by the dielectric fluid 608.

The supercell 604 with the dielectric fluid 608 inside the housing 106 may be used in high-performance battery systems as it exhibits improved cooling characteristics and improved operational efficiency.

The supercell 604 incorporates usage of the dielectric fluid 608 for passive cooling without the need for a complex external circulation feature. Thus, the supercell 604 described herein does not need additional provisions for connecting to any external circulation feature for the dielectric fluid 608. Instead, the present disclosure teaches passive cooling that is based completely on natural convection and latent heat. The usage of dielectric fluid 608 may reduce a risk of leakage, simplify a fluid flow path design, and increase temperature distribution. Furthermore, the supercell 604 includes the channel assemblies 618, 620, 622 that not only promote heat transfer but also accommodate swelling of the first and second pouch cells 624, 626 during the recharging process.

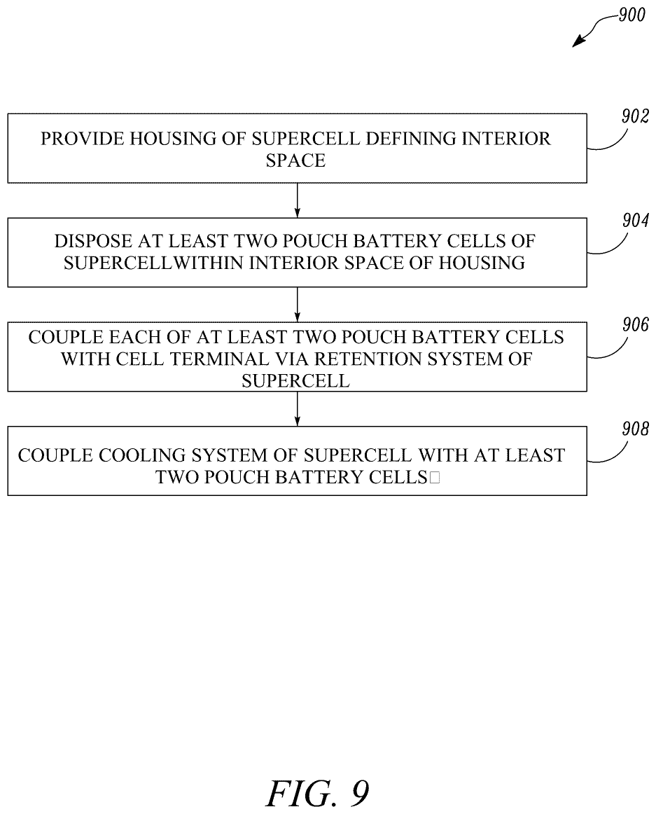

FIG. 9 is a flowchart for a method 900 of assembling the supercell 104, 404, 604 of the battery assembly 100. At the step 902, the housing 106 of the supercell 104, 404, 604 defining the interior space 119 is provided. The housing 106 extends along each of the longitudinal axis A1, the lateral axis A2, and the transverse axis A3. The cell terminal 144 of the supercell 104, 404, 604 is coupled with the housing 106.

At step 904, the two or more pouch battery cells 120 of the supercell 104, 404, 604 are disposed within the interior space 119 of the housing 106. The two or more pouch battery cells 120 are disposed adjacent to each other along the lateral axis A2.

In an example, the step 904 further includes receiving the two or more pouch battery cells 120 are received with the holder 122 of the supercell 104, 404, 604. The holder 122 includes the top wall 124 extending along the longitudinal axis A1 of the housing 106. The top wall 124 includes the number of first tabs 126. The holder 122 also includes the bottom wall 128 spaced apart from the top wall 124 and extending along the longitudinal axis A1 of the housing 106. The number of first tabs 126 extend orthogonally towards the bottom wall 128. The bottom wall 128 includes the number of second tabs 130. The number of second tabs 130 extend orthogonally towards the top wall 124. The holder 122 further includes the first sidewall 116 extending along the transverse axis A3 of the housing 106 from the top wall 124 to the bottom wall 128 and disposed at the first end of the housing 106. The holder 122 includes the second sidewall 118 extending along the transverse axis A3 of the housing 106 from the top wall 124 to the bottom wall 128 and disposed at the second end of the housing 106.

The step 904 further includes engaging each of the number of first tabs 126 and the number of second tabs 130 are engaged with the corresponding pouch battery cell 120 from the two or more pouch battery cells 120. The step 904 further includes disposing the holder 122 and the two or more pouch battery cells 120 as the unit within the housing 106.

At step 906, each of the two or more pouch battery cells 120 are coupled with the cell terminal 144 via the coupling system 142 of the supercell 104, 404, 604.

At step 908, the cooling system 606 of the supercell 104, 404, 604 is coupled with the two or more pouch battery cells 120. The cooling system 606 is at least partially disposed within the interior space 119 of the housing 106.

In an example, the step 908 further includes immersing each of the two or more pouch battery cells 120 in the dielectric fluid 608 of the cooling system 606. The dielectric fluid 608 is received within the housing 106. The step 908 further includes disposing the number of channel assemblies 618, 620, 622 of the cooling system 606 are disposed within the interior space 119 of the housing 106. The first channel assembly 618 from the number of channel assemblies 618, 620, 622 is disposed between the housing 106 and the first pouch cell 624 from the two or more pouch battery cells 120, the second channel assembly 620 from the number of channel assemblies 618, 620, 622 is disposed between the first pouch cell 624 and the second pouch cell 626 from the two or more pouch battery cells 120, and the third channel assembly 622 from the number of channel assemblies 618, 620, 622 is disposed between the housing 106 and the second pouch cell 626. Each of the number of channel assemblies 618, 620, 622 includes the number of tubes 628 that extend along the transverse axis A3 and the number of plates 630 that extend along the longitudinal axis A1. Each tube 628 from the number of tubes 628 is coupled to each of the number of plates 630. Each tube 628 from the number of tubes 628 allows passage of the dielectric fluid 608 therethrough.

The method 900 further includes a step (not shown) at which the compressible member 140 of the supercell 104, 404 is disposed between the two or more pouch battery cells 120.

It should be noted that the steps 902, 904, 906, 908 of the method 900 may be performed in the sequence that is different from that explained in relation to FIG. 9. Further, various steps 902, 904, 906, 908 can be performed together.

While aspects of the present disclosure have been particularly shown and described with reference to the embodiments above, it will be understood by those skilled in the art that various additional embodiments may be contemplated by the modification of the disclosed work machine, systems, and methods without departing from the spirit and scope of the disclosure. Such embodiments should be understood to fall within the scope of the present disclosure as determined based upon the claims and any equivalents thereof.

What is claimed is:

1. A supercell for a battery assembly, the supercell comprising:
a housing defining an interior space, the housing extending along each of a longitudinal axis, a lateral axis, and a transverse axis;
a cell terminal coupled with the housing;
at least two pouch battery cells disposed within the interior space of the housing, wherein the at least two pouch battery cells are disposed adjacent to each other along the lateral axis;
a coupling system that couples each of the at least two pouch battery cells with the cell terminal; and
a cooling system for the at least two pouch battery cells, wherein the cooling system is at least partially disposed within the interior space of the housing.

2. The supercell of claim 1 further comprising a holder disposed within the housing and coupled with each of the at least two pouch battery cells, wherein the holder includes:
a top wall extending along the longitudinal axis of the housing and including a plurality of first tabs;
a bottom wall spaced apart from the top wall and extending along the longitudinal axis of the housing, wherein the plurality of first tabs extend orthogonally towards the bottom wall, wherein the bottom wall includes a plurality of second tabs, wherein the plurality of second tabs extend orthogonally towards the top wall, and wherein each of the plurality of first tabs and the plurality of second tabs couple the at least two pouch battery cells with the holder;
a first wall extending along the transverse axis of the housing from the top wall to the bottom wall and disposed at a first end of the housing; and
a second wall extending along the transverse axis of the housing from the top wall to the bottom wall and disposed at a second end of the housing.

3. The supercell of claim 1 further comprising a compressible member disposed between the at least two pouch battery cells.

4. The supercell of claim 1, wherein the at least two pouch battery cells includes a first pouch cell, a second pouch cell, and a third pouch cell disposed adjacent to each other, the supercell further comprising a heat dissipating sheet wrapped around each of the first pouch cell, the second pouch cell, and the third pouch cell, wherein a portion of the heat dissipating sheet is disposed between the first pouch cell and the housing, and a portion of the heat dissipating sheet is disposed between the third pouch cell and the housing.

5. The supercell of claim 1, wherein the cooling system includes a dielectric fluid received within the interior space of the housing, and wherein each of the at least two pouch battery cells is immersed in the dielectric fluid.

6. The supercell of claim 5, wherein the cooling system includes a condenser disposed atop the housing for heat exchange with the dielectric fluid.

7. The supercell of claim 5, wherein the cooling system includes a plurality of channel assemblies disposed within the interior space of the housing, wherein each of the plurality of channel assemblies is made of a compressible material, wherein a first channel assembly from the plurality of channel assemblies is disposed between the housing and a first pouch cell from the at least two pouch battery cells, a second channel assembly from the plurality of channel assemblies is disposed between the first pouch cell and a second pouch cell from the at least two pouch battery cells, and a third channel assembly from the plurality of channel assemblies is disposed between the housing and the second pouch cell, wherein each of the plurality of channel assemblies includes a plurality of tubes that extend along the transverse axis and a plurality of plates that extend along the longitudinal axis, wherein each tube from the plurality of tubes is coupled to each of the plurality of plates, and wherein each tube from the plurality of tubes allows passage of the dielectric fluid therethrough.

8. The supercell of claim 1, wherein the coupling system includes a first plate, and a second plate including a pair of projections, wherein the pair of projections of the second plate are fixedly coupled with the cell terminal, and wherein a portion of a cell tab of each of the at least two pouch battery cells is disposed between the first plate and the second plate and fixedly coupled with each of the first plate and the second plate.

9. A battery assembly comprising:
a battery housing; and
a plurality of supercells disposed within the battery housing, wherein each of the plurality of supercells includes:
a housing defining an interior space, the housing extending along each of a longitudinal axis, a lateral axis, and a transverse axis;
a cell terminal coupled with the housing;
at least two pouch battery cells disposed within the interior space of the housing, wherein the at least two pouch battery cells are disposed adjacent to each other along the lateral axis;
a coupling system that couples each of the at least two pouch battery cells with the cell terminal; and
a cooling system for the at least two pouch battery cells, wherein the cooling system is at least partially disposed within the interior space of the housing.

10. The battery assembly of claim 9, wherein each of the plurality of supercells further includes a holder disposed within the housing and coupled with each of the at least two pouch battery cells, and wherein the holder includes:
a top wall extending along the longitudinal axis of the housing and including a plurality of first tabs;
a bottom wall spaced apart from the top wall and extending along the longitudinal axis of the housing, wherein the plurality of first tabs extend orthogonally towards the bottom wall, wherein the bottom wall includes a plurality of second tabs, wherein the plurality of second tabs extend orthogonally towards the top wall, and wherein each of the plurality of first tabs and the plurality of second tabs couple the at least two pouch battery cells with the holder;
a first wall extending along the transverse axis of the housing from the top wall to the bottom wall and disposed at a first end of the housing; and
a second wall extending along the transverse axis of the housing from the top wall to the bottom wall and disposed at a second end of the housing.

11. The battery assembly of claim 9, wherein each of the plurality of supercells further includes a compressible member disposed between the at least two pouch battery cells.

12. The battery assembly of claim 9, wherein the at least two pouch battery cells includes a first pouch cell, a second pouch cell, and a third pouch cell disposed adjacent to each other, wherein the supercell further includes a heat dissipating sheet wrapped around each of the first pouch cell, the second pouch cell, and the third pouch cell, and wherein a portion of the heat dissipating sheet is disposed between the first pouch cell and the housing, and a portion of the heat dissipating sheet is disposed between the third pouch cell and the housing.

13. The battery assembly of claim 9, wherein the cooling system includes a dielectric fluid received within the interior space of the housing, and wherein each of the at least two pouch battery cells is immersed in the dielectric fluid.

14. The battery assembly of claim 13, wherein the cooling system includes a condenser disposed atop the housing for heat exchange with the dielectric fluid.

15. The battery assembly of claim 13, wherein the cooling system includes a plurality of channel assemblies disposed within the interior space of the housing, wherein each of the plurality of channel assemblies is made of a compressible material, wherein a first channel assembly from the plurality of channel assemblies is disposed between the housing and a first pouch cell from the at least two pouch battery cells, a second channel assembly from the plurality of channel assemblies is disposed between the first pouch cell and a second pouch cell from the at least two pouch battery cells, and a third channel assembly from the plurality of channel assemblies is disposed between the housing and the second pouch cell, wherein each of the plurality of channel assemblies includes a plurality of tubes that extend along the transverse axis and a plurality of plates that extend along the longitudinal axis, wherein each tube from the plurality of tubes is coupled to each of the plurality of plates, and wherein each tube from the plurality of tubes allows passage of the dielectric fluid therethrough.

16. The battery assembly of claim 9, wherein the coupling system includes a first plate, and a second plate including a pair of projections, wherein the pair of projections of the second plate are fixedly coupled with the cell terminal, and wherein a portion of a cell tab of each of the at least two pouch battery cells is disposed between the first plate and the second plate and fixedly coupled with each of the first plate and the second plate.

17. A method of assembling a supercell of a battery assembly, the method comprising:
providing a housing of the supercell defining an interior space, the housing extending along each of a longitudinal axis, a lateral axis, and a transverse axis, wherein a cell terminal of the supercell is coupled with the housing;
disposing at least two pouch battery cells of the supercell within the interior space of the housing, wherein the at least two pouch battery cells are disposed adjacent to each other along the lateral axis;
coupling each of the at least two pouch battery cells with the cell terminal via a coupling system of the supercell; and
coupling a cooling system of the supercell with the at least two pouch battery cells, wherein the cooling system is at least partially disposed within the interior space of the housing.

18. The method of claim 17, wherein the step of disposing the at least two pouch battery cells within the interior space of the housing further includes:
receiving the at least two pouch battery cells with a holder of the supercell, wherein the holder includes:
a top wall extending along the longitudinal axis of the housing and including a plurality of first tabs;
a bottom wall spaced apart from the top wall and extending along the longitudinal axis of the housing, wherein the plurality of first tabs extend orthogonally towards the bottom wall, wherein the bottom wall includes a plurality of second tabs, and wherein the plurality of second tabs extend orthogonally towards the top wall;
a first wall extending along the transverse axis of the housing from the top wall to the bottom wall and disposed at a first end of the housing; and
a second wall extending along the transverse axis of the housing from the top wall to the bottom wall and disposed at a second end of the housing;
engaging each of the plurality of first tabs and the plurality of second tabs with a corresponding pouch battery cell from the at least two pouch battery cells; and
disposing the holder and the at least two pouch battery cells as a unit within the housing.

19. The method of claim 17 further comprising disposing a compressible member of the supercell between the at least two pouch battery cells.

20. The method of claim 17, wherein the step of coupling the cooling system of the supercell with the at least two pouch battery cells further includes:
immersing each of the at least two pouch battery cells in a dielectric fluid of the cooling system, wherein the dielectric fluid is received within the housing; and
disposing a plurality of channel assemblies of the cooling system within the interior space of the housing, wherein a first channel assembly from the plurality of channel assemblies is disposed between the housing and a first pouch cell from the at least two pouch battery cells, a second channel assembly from the plurality of channel assemblies is disposed between the first pouch cell and a second pouch cell from the at least two pouch battery cells, and a third channel assembly from the plurality of channel assemblies is disposed between the housing and the second pouch cell, wherein each of the plurality of channel assemblies includes a plurality of tubes that extend along the transverse axis and a plurality of plates that extend along the longitudinal axis, wherein each tube from the plurality of tubes is coupled to each of the plurality of plates, and wherein each tube from the plurality of tubes allows passage of the dielectric fluid therethrough.
